(19) United States
(12) Patent Application Publication
(10) Pub. No.: US 2012/0083902 A1
(43) Pub. Date: Apr. 5, 2012

(54) COMMUNICATION SYSTEM AND METHOD FOR COMMUNICATING BETWEEN MASTER AND SLAVE DEVICES

(76) Inventors: Wolf Daum, Erie, PA (US); Gerald Rose, Erie, PA (US)

(21) Appl. No.: 12/894,801

(22) Filed: Sep. 30, 2010

(51) Int. Cl. G05B 15/02

(52) U.S. Cl. 700/3

(57) ABSTRACT

A communication system includes: a master control device capable of being coupled with a conductive communications pathway of a group of conductive pathways, the master control device including a signal modulator configured to transmit a power signal and a command signal along the communications pathway by modulating an electric current supplied by a power source joined with the group of conductive pathways; and a load module capable of being coupled with the communications pathway in series with the master control device and of being coupled with a slave device, the load module configured to receive the power signal and the command signal from the master control device along the communications pathway, wherein the power signal activates the load module and the command signal directs the load module to control the slave device and to cause the slave device to take an action.

### BACKGROUND

1. Technical Field

The subject matter described herein relates to communication systems between master and slave devices in a vehicle, such as an electric vehicle.

2. Discussion of Art

Known electric vehicles include powered rail vehicles, such as locomotives, and off-highway vehicles (OHV), such as open mining trucks. Electric vehicles may be electric-only (e.g., battery powered), or they may include fuel engines for generating electricity for driving traction motors and other electric loads. These electric vehicles may include many electromechanical devices to perform various actions during operation of the vehicles. For example, some known electric vehicles include contactors, relays, and/or switches that alternatively open and close to open and close electric circuits of the electric vehicles. Some known electric vehicles include sensors that obtain measurements or readings to ensure that the electric vehicles are operating safely.

The electromechanical devices of the electric vehicles may be electrically coupled with processors of the electric vehicles by two or more wires. One wire (the “power wire”) can provide electric current to the electromechanical device while another wire (the “communication wire”) provides data, such as commands, directions, or instructions, from the processor to the electromechanical device. The power wire and the communication wire may be electrically separate from each other as electric current is supplied on the power wire while digital data may be communicated on the communication wire.

Some known electric vehicles include many electromechanical devices and, as a result, may include thousands of power and communication wires. As the number of electromechanical devices and wires increases, the manufacturing cost involved in providing the electric vehicle increases. Moreover, as the number of power and communication wires increases, the chance of one or more wires failing or being damaged and cutting off the supply of power and/or communication between the electromechanical devices and processor can increase.

It may be desirable to have a communication system and method for communicating with devices such as electromechanical devices of an electric vehicle engine that reduces the manufacturing cost and/or the risk of failure of the communication system.

### BRIEF DESCRIPTION

In one embodiment, a communication system includes: a master control device capable of being coupled with a conductive communications pathway of a group of conductive pathways, the master control device including a signal modulator configured to transmit a power signal and a command signal along the communications pathway by modulating an electric current supplied by a power source joined with the group of conductive pathways; and a load module capable of being coupled with the communications pathway in series with the master control device and of being coupled with a slave device, the load module configured to receive the power signal and the command signal from the master control device along the communications pathway, wherein the power signal activates the load module and the command signal directs the load module to control the slave device and to cause the slave device to take an action.

In another embodiment, a method for communicating in a communication system includes: transmitting a power signal and a command signal from a master control device to a load module coupled with a slave device along a conductive communications pathway of a group of conductive pathways, the power signal and the command signal transmitted by modulating an electric current supplied by a power source; receiving the power signal at the load module and activating the load module based on energy of the power signal; and receiving the command signal at the load module, the load module directing the slave device to take an action based on the command signal.

In another embodiment, a communication system includes: a master control device capable of being coupled with a conductive communications pathway formed from one or more conductive bodies joined in series with each other and formerly used to communicate data signals in a vehicle, the master control device including a signal modulator configured to transmit a power signal and a command signal along the communications pathway by modulating an electric current supplied by a power source; and a load module capable of being coupled with the communications pathway and with a slave device, the load module configured to receive the power signal and the command signal from the master control device along the communications pathway, wherein the power signal activates the load module and the command signal directs the load module to control the slave device and to cause the slave device to take an action.

### BRIEF DESCRIPTION OF THE DRAWINGS

FIG. 1 is an illustration of an electric vehicle in accordance with one embodiment.

FIG. 2 is a circuit diagram of a portion of a communications system shown in FIG. 1 in accordance with one embodiment.

FIG. 3 is a diagram of an expandable communication system in accordance with one embodiment.

FIGS. 4A and 4B illustrate a flowchart of a method for communicating within a communications system in accordance with one embodiment.

### DETAILED DESCRIPTION

The subject matter described herein relates to communication systems and methods for communicating between master control devices and slave devices in an electric vehicle, such as a diesel electric locomotive, automobiles, and mining equipment. Mining equipment can include underground mining apparatus or above ground mining apparatus, such as an off-highway vehicle (OHV). The systems and methods allow a master control device to both power and command one or more load modules along a conductive communications pathway, such as a conductive bus or a wire. The load modules direct the slave devices to perform an action, such as open or close a relay, open or close a switch, or obtain a signal from a sensor that is representative of a reading or measurement obtained by the sensor. In one embodiment, one or more master control devices power and communicate data with several load modules over a single bus or wire. In some existing electric vehicles, one or more embodiments described herein may be used to retrofit an existing wired communications network between one or more master control devices and several load modules so that the master control devices both power and command the load modules over the common bus or wire that previously was used only to command the load modules, but not to power the load modules. For example, one or more embodiments described herein may be used to retrofit existing circuits in a vehicle that previously were used for one or more other functions. By retrofitting existing circuits, one or more of the systems and methods described herein can be implemented in existing vehicles without significant additional expense.

It should be noted that although one or more embodiments may be described in connection with electric vehicles such as locomotives and other OHV, the embodiments described herein are not limited to locomotives and OHV. In particular, one or more embodiments may be implemented in connection with different types of rail vehicles and other non-rail vehicles. For example, one or more embodiments may be implemented with a vehicle that travels on one or more rails, such as single locomotives and railcars, powered ore carts and other mining vehicles, light rail transit vehicles, and the like. Alternatively, one or more embodiments may be implemented with non-rail vehicles such as automobiles, marine vessels, and other vehicles capable of self-propulsion. As another example, one or more embodiments described herein may be implemented in connection with non-vehicular devices, such as stationary power systems.

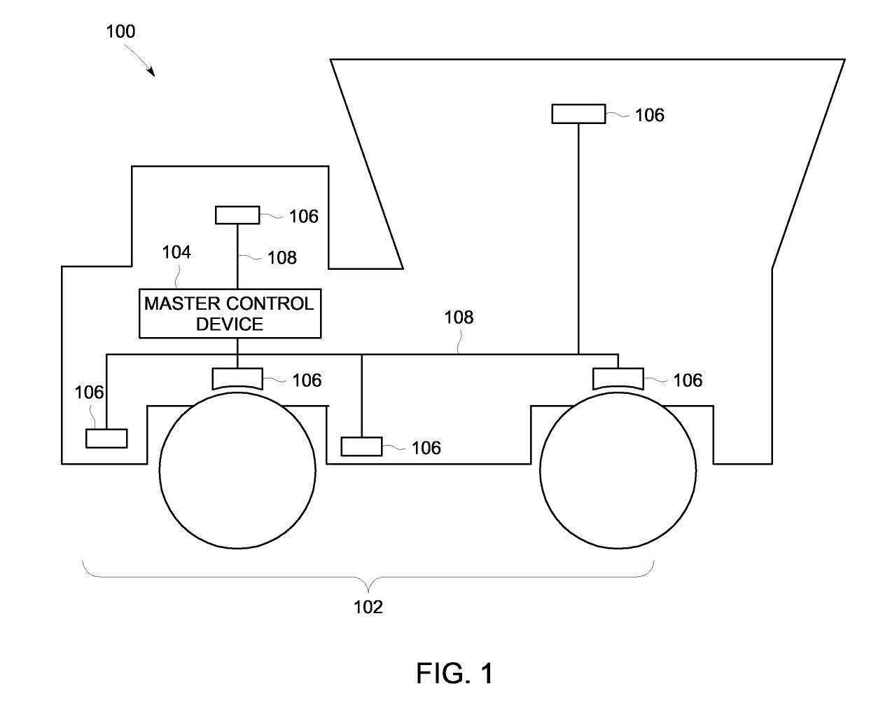

FIG. 1 is an illustration of an electric vehicle 100 in accordance with one embodiment. The vehicle 100 may be a diesel-electric vehicle having a diesel engine coupled with a current-generating device, such as an alternator or generator. Movement of the engine is converted into electric current by the current-generating device. By way of non-limiting example only, the vehicle 100 may be a powered unit of a rail vehicle, such as a locomotive, a mining truck, or excavator. In one or more embodiments where the vehicle 100 is a mining truck or excavator, the vehicle 100 may have a 100 to 400-ton carrying capacity. Alternatively, the vehicle 100 may have a smaller or larger carrying capacity. The vehicle 100 may have a power-to-weight ratio of less than 10 horsepower (h.p.) per ton, such as a ratio of 5 h.p. per ton.

The vehicle 100 includes a communication system 102 that enables one or more master control devices 104 to communicate with and direct actions of one or more slave devices 106. The communication system 102 may use one or more communication protocols, such as the controller area network (CAN) protocol, Internet protocol (IP), Transmission Control Protocol (TCP), User Datagram protocol (UDP), Internet Control Message protocol (ICMP), and the like. The communication system 102 may be a distributed control system in one embodiment. For example, several master control devices 104 may be provided in the vehicle 100 with each master control device 104 controlling one or more slave devices 106 using the communication system 102 or using several different or separate communication systems 102. The illustration of a single master control device 104 in FIG. 1 is provided merely as an example. Additional master control devices 104 may be used. For example, multiple master control devices 104 may be coupled with each other and with the slave devices 106 in a distributed communication system 102. Alternatively, the communication system 102 may be a centralized control system having a centrally located master control device 104 that communicates with the slave devices 106.

The slave devices 106 may be remote from the master control device 104. For example, the slave devices 106 may be separate from and spaced apart from the master control device 104. The slave devices 106 may be spaced apart from the master control device 104 when the slave devices 106 are not located in the same compartment or housing within the vehicle 100 as the master control device 104. For example, the master control device 104 may be located in the dashboard or cab of the vehicle 100 while the slave devices 106 are located at or near wheels or brakes of the vehicle 100, or are located in another car or unit that is being propelled or towed by the vehicle 100, such as a passenger train car. As another example, the slave devices 106 may be remote from the master control device 104 when the slave devices 106 are not coupled to the same board, chassis, machine, and the like, as the master control device 104.

The master control device 104 is electrically coupled with the slave devices 106 by a conductive communications pathway 108. The communications pathway 108 may be formed from one or more conductive bodies that are electrically coupled with each other in series to form a common or single bus that permits the master control device 104 to transmit power signals and command signals to the slave devices 106. In one embodiment, the conductive communications pathway 108 is a single serial pathway, such as a single wire or bus, with a return to ground, such as another wire or bus that is electrically coupled with a chassis of the vehicle 100 or a ground reference. The communications pathways 108 may be conductive buses or wires that previously were used to communicate data signals in the vehicle 100. For example, a single wire may extend from the master control device 104 to the slave devices 106 controlled by the master control device 104, with the master control device 104 both powering and controlling the slave devices 106 over the single wire. The single wire may be a signal wire or a power wire in a preexisting network of conductive wires used to communicate data signals (over the signal wire) and to supply electric power (over the power wire) between devices in a vehicle 100. Alternatively, multiple wires or buses may couple the master control device 104 with the slave devices 106.

In one embodiment, the communication pathways 108 that couple the master control device 104 with the slave devices 106 forms a common or single bus to which all of the slave devices 106 and master control device 104 are electrically coupled. Additional master control devices 104 and slave devices 106 may be added to the communication system 102 by coupling the additional master control devices 104 and slave devices 106 to the common communication pathway 108, such as in a daisy-chain arrangement. The common bus formed by the communication pathways 108 may be a preexisting circuit in the vehicle 100. For example, prior to including the master control device 104 and/or the slave devices 106 to the vehicle 100, the communication pathways 108 may be present in the vehicle 100 as a preexisting network or bus. The preexisting communication pathways 108 may be used for one or more other functions prior to adding the master control device 104 and/or the slave devices 106 to the vehicle 106. In one embodiment, the communications pathways 108 are the wires or buses used in an existing communication system to only communicate data or control signals. Additional wires or buses may have been previously used in addition to the data or control signal wires to transfer power to the slave devices 106. The master control device 104 may be added or retrofitted to the preexisting network to add one or more features or functions described herein without significantly adding to the expense of the vehicle 100.

The slave devices 106 may be devices that respond to electric signals from the master control device 104 to take an action. By way of non-limiting examples, the slave devices 106 may include contactors, relays, switches, or sensors. The master control device 104 directs the slave devices 106 to take one or more actions, such as opening or closing the contactor, relay, or switch, or to obtain a signal from the sensor, such as a signal that represents a sensor reading or measurement.

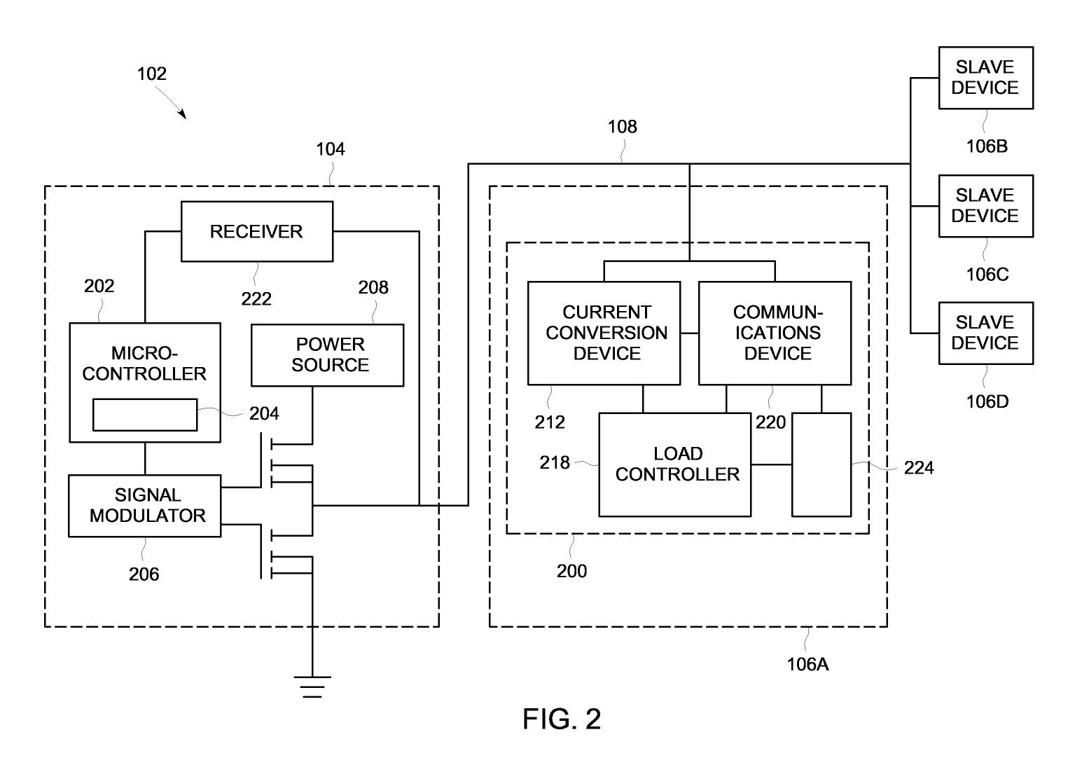

FIG. 2 is a circuit diagram of a portion of the communications system 102 in accordance with one embodiment. The portion of the communications system 102 that is shown in FIG. 2 includes the master control device 104 coupled with several slave devices 106 by one of the communications pathways 108. The letter suffixes A, B, C, and D are used to label the slave devices 106 to provide easier reference to the different slave devices 106.

In the illustrated embodiment, the slave devices 106 include load modules 200. While each slave device 106 is shown as including only a single load module 200, alternatively several slave devices 106 may be coupled with a single load module 200. The master control device 104 communicates power and command signals to the load modules 200 through a common or single wire or bus that is formed by or includes the communications pathways 108. The power signals energize the slave devices 106 and the command signals direct the slave devices 106 to cause the slave devices 106 to take an action. In one embodiment, the load modules 200 are coupled with, but not included in, the slave devices 106. For example, the load modules 200 may be devices that are separate from the slave devices 106 and coupled with the slave devices 106 using one or more wires or cables. As another example, the load modules 200 may be separate from and communicate with the slave devices 106 using a wireless connection.

In the illustrated embodiment, the master control device 104 includes a microcontroller 202. Alternatively, the master control device 104 may include a different logic device, such as a computer processor. The microcontroller 202 operates based on one or more sets of instructions stored on a computer readable storage medium 204. The sets of instructions may be one or more programs or hard-wired instructions that direct the microcontroller 202 to take one or more actions or perform one or more steps. The computer readable storage medium 204 may be a tangible and non-transitory medium, such as a computer hard drive, flash memory, random access memory, read only memory, DRAM, SRAM, and the like.

The microcontroller 202 is electrically coupled with a signal modulator 206. The signal modulator 206 is electrically coupled with a power source 208. The power source 208 provides electric current to the signal modulator 208. The power source 208 may be an energy storage device, such as a battery, that stores energy for later use. Alternatively, the power source 208 may be an energy generating device, such as an alternator or generator, that generates energy from the conversion of movement, such as the movement of a shaft joined to an engine. The signal modulator 206 may be coupled with the power source 208 by a driver circuit, such as a driver circuit that includes one or more field effect transistors (FET). While the power source 208 is illustrated as a local power source disposed within the master control module 104, alternatively the power source 208 may be disposed outside of the master control module 104, such as by being remote from the master control module 104.

The microcontroller 202 directs the signal modulator 206 to generate and transmit the power and command signals to the slave devices 106. In one embodiment, the signal modulator 206 is a pulse-width modulator that controls delivery of electric current from the power source 208 to create the power and command signals. For example, the signal modulator 206 may alternatively turn the flow of electric current from the power source 208 on and off in order to transmit the power and command signals as pulses of the electric current from the power source 208. The signal modulator 206 varies the timing of turning the flow of electric current on and off, such as by varying the duration and/or frequency that the electric current flows from the power source 208 to the slave device 106, in order to create the power and command signals. The signal modulator 206 may convert a direct current obtained from the power source 208 into an alternating current that is transmitted as the power signal. In one embodiment, the signal modulator 206 may change the polarity of the electric current flowing from the power source 208.

In one embodiment, the master control device 104 selects which of the load module 200 of the slave devices 106 that the master control device 104 will communicate with (referred to as “selected slave devices 106”). The master control device 104 may asynchronously communicate with a single or multiple slave devices 106. For example, instead of synchronizing communications with all or a subset of the slave devices 106 such that the several communications with the individual slave devices 106 are coordinated with each other with respect to time, the master control device 104 may individually select the slave devices 106 that the master control device 104 communicates with, regardless of which other slave devices 106 that the master control device 104 previously communicated with or will communicate with and regardless of when the prior or future communications occur. The master control device 104 may select the slave devices 106 based on a predetermined pattern or polling sequence, a random pattern or sequence, or based on input from an operator of the communication system 102. For example, the master control device 104 may include or be coupled with an input device, such as a button, switch, keyboard, microphone, touchscreen, and the like, that allows an operator to select which slave devices 106 will communicate with the master control device 104.

Once the master control device 104 determines which slave device 106 that the master control device 104 will communicate with, microcontroller 202 of the master control device 104 directs the signal modulator 206 to create a power signal to turn on and/or energize the selected slave device 106. The signal modulator 206 generates the power signal and transmits the power signal along the communications pathway 108 to the slave devices 106. One or more parameters of the power signal may be based on the selected slave device 106. For example, the amplitude, frequency, phase, and/or duration of the pulses of current from the power source 208 that form the power signal may be increased to increase the energy conveyed or included in the power signal. Conversely, the duration and/or frequency of the pulses of current may be decreased to decrease the energy in the power signal. The signal modulator 206 may transmit power signals of greater energy to the slave devices 106 that require more energy to turn on or power the slave devices 106 than the power signals transmitted to the slave devices 106 that require less energy.

In one embodiment, the microcontroller 202 directs the signal modulator 206 to include a unique address or identification (collectively “address”) of the load module 200 of the selected slave device 106 in the power signal. The load modules 200 of the slave devices 106 may be associated with respective uniquely defined addresses. For example, each load module 200 can have an address that is different from the other load modules 200. (Thus, “uniquely” defined means each address within a contiguous communications system of the vehicle is different; if there are multiple non-contiguous communication systems within a vehicle, i.e., the communication systems do not communicate with one another, then each communication system may include a set of uniquely defined addresses despite the fact that the addresses in one of the communication system may be the same as the addresses in the other communication system.) The address of the load module 200 of the selected slave device 106 may be encoded in the power signal by the signal modulator 206 at one or more initial frames of the power signal. For example, the signal modulator 206 can use pulsed wave modulation (PWM) to pulse the direct current from a battery and create a signal having an address frame that leads the pulse wave modulated power signal. Alternatively, the signal modulator 206 may use phase shift modulation, amplitude modulation, and/or frequency modulation to create the signal. The address of one or more load module 200 of the slave devices 106 may be encoded in the power signal by changing the duration and/or frequency of one or more pulses of current from the power source 208. The power signal that includes the address can be communicated to the load module 200 of the slave devices 106 along the conductive pathway 108.

Alternatively, multiple load modules 200 may have the same address or may not be associated with unique addresses. In such an embodiment, one of the load modules 200 that is associated with an address can be designated as a sub-master load module 200 and one or more of the other load modules 200 having the same address or no address are coupled with the sub-master load module 200. For example, the other load modules 200 may be serially coupled with the sub-master load module 200 in a daisy-chain arrangement. The address of the sub-master load module 200 may be encoded in power signals that are directed to one or more of the by the signal modulator 206 at one or more initial frames of the power signal. The power signal that includes the address of the sub-master load module 200 can be communicated to one or more of the other load modules 200 that are coupled with the sub-master load module 200.

In another embodiment, one or more of the load modules 200 are not associated with unique addresses. For example, sets or groups of the load modules 200 may be serially connected with sub-master load modules 200 in a daisy chain connection, yet not be associated with independent or unique addresses. The power signals for one or more of the load modules 200

In the illustrated embodiment, the load modules 200 of the slave devices 106 include communications devices 220 that receive and demodulate signals communicated along the conductive pathway 108. For example, the communications devices 220 may demodulate the power signal to determine the address encoded in the power signals. The communications devices 220 determine if the address of the power signal matches the address of the load module 200 of the associated slave device 106. If the address of the power signal matches the address of the load module 200 of the slave device 106, then the communications device 220 of the slave device 106 determines that the slave device 106 is a selected slave device 106. The communications device 220 receives and transmits the power signal to a current conversion device 212 of the selected slave device 106. Conversely, if the address of the power signal does not match the address of the slave device 106, then the communications device 220 determines that the slave device 106 is not a selected slave device 106 and directs the current conversion device 212 (and, as a result, the slave device 106) to ignore the power signal.

Alternatively, the master control device 104 may broadcast a power signal or multiple power signals to one or more load modules 200 of the slave devices 106 along the conductive pathway 108 without addressing the power signal to one or more selected slave devices 106. The amount of energy in the power signal may be sufficient to power only certain types or categories of slave devices 106, or may be sufficient to power all or at least a predetermined number of the slave devices 106.

The current conversion device 212 of the selected slave device 106 receives the energy of the power signal in order to turn on and/or power the selected slave device 106. For example, the current conversion device 212 may include a rectifier that receives the pulses of the power signal and rectifies the power signal into a direct current. The current conversion device 212 may include a filter to remove one or more frequencies of the power signal. The direct current that is output by the current conversion device 212 is used to turn on and/or power the selected slave device 106. For example, prior to receiving and rectifying the power signal, the selected slave device 106 may be turned off or deactivated. The power signal may contain sufficient energy to power the selected slave device 106 long enough for the slave device 106 to perform the action directed by the command signal. The current conversion device 212 may produce a direct current from the power signal that has sufficient duration to power the slave device 106. Alternatively, the slave device 106 may include or be coupled with another power source, such as a battery. Receipt of the power signal by the selected slave device 106 may turn the slave device 106 on and cause the slave device 106 to begin drawing power from the power source via the power signal.

In one embodiment, once the selected slave device 106 is powered by and/or receives the power signal, the load module 200 of the slave device 106 transmits a responsive signal to the master control device 104. The responsive signal may include a self identification sequence code. For example, once a slave device 106 is energized by a power signal, the slave device 106 may being a self-authentication process to authenticate the slave device 106 to the master control device 104 by transmitting a self identification sequence code. The self-authentication process notifies the master control device 104 of the presence of the slave device 106 (such as a notification to the master control device 104 that the slave device 106 is available to perform one or more actions based on commands from the master control device 104) and/or that the slave device 106 is powered on or otherwise activated.

In the self-authentication process, the load module 200 of the slave device 106 transmits a self authenticating code or signal to the master control device 104. The self authenticating code or signal may be transmitted along the communications pathway 108, such as a signal wire or bus of a preexisting communication system, or along another conductive body, such as a power wire or bus of the preexisting communication system. The self authenticating code may include a self identification sequence code that includes the unique address of the load module 200 of the selected slave device 106 in one embodiment. The load module 200 of the slave device 106 transmits the self identification sequence code in order to notify the master control device 104 that the load module 200 of the slave device 106 received and/or is activated by the power signal. The communications device 220 may include a transceiver or a transmitter-receiver that transmits a data signal having one or more data packets to the master control device 104 through the communications pathway 108. The data packets form the self identification sequence code and may include the address of the load module 200 of the activated slave device 106. The master control device 104 receives the self identification sequence code from the load module 200 of the slave device 106. The receipt of the self identification sequence code can serve as an acknowledgement or confirmation that the load module 200 of the slave device 106 is activated and that a communication link has been established between the load module 200 and the master control device 104. Once the master control device 104 receives this acknowledgement from the load module 200, the master control device 106 transmits one or more data signals to the load module 200 along the conductive pathway 108.

In one embodiment, the master control device 104 concurrently or simultaneously transmits power signals to two or more load modules 200 of different slave devices 106. In order to prevent the activated load modules 200 from concurrently or simultaneously transmitting self identification sequence codes to the master control device 104 over the common or single conductive pathway 108, each of the activated slave devices 106 may wait until the conductive pathway 108 is available for transmission of the self identification sequence code for that load module 200. For example, the communications devices 220 of each of the activated slave devices 106 may monitor a communications channel that includes the conductive pathway 108 between the master control device 104 and the activated slave device 106. The communications devices 220 may monitor the communications channel to determine if any signals or codes are being transmitted by other slave devices 106 and/or the master control device 104 through the communications channel. If no other signals or codes are being transmitted, then the load module 200 of the activated slave device 106 that is monitoring the communications channel transmits the self identification sequence code to the master control device 104. Load modules 200 of the other activated slave devices 106 also wait until the communications channel is clear before each activated slave device 106 transmits an associated self identification sequence code to the master control device 104.

In one embodiment, the master control device 104 identifies which of the load modules 200 transmits the self identification sequence codes to the master control device 104 based on a transmission characteristic of the load module. The transmission characteristic may represent a time delay or time difference between transmission of the self identification sequence codes by a plurality of the load modules 200. Such a time delay or difference may be referred to as a “transmission time delay.” For example, if the load modules 200 transmit the self identification sequence codes based on their associated addresses and/or at times separated by predetermined time delays, the master control device 104 may use the sequence or timing of the transmission of the self identification sequence codes (such as the time delay between two load modules 200 transmitting respective self identification sequence codes) to determine which load modules 200 transmitted the self identification sequence codes.

As one example, different load modules 200 may wait until the conductive pathway 108 is available for transmission of the self identification sequence codes of the load modules 200. Once the conductive pathway 108 is available (for example, when no other load modules 200 are transmitting on the conductive pathway 108), a first load module 200 may wait a first predetermined transmission time delay before transmitting an associated self identification sequence code and a second load module 200 may wait a longer second transmission time delay before transmitting an associated self identification sequence code. The difference between the transmission time delays of the self identification sequence codes by the first and second load modules 200 may permit the master control device 104 to receive both self identification sequence codes without the codes interfering with each other.

In another embodiment, the load modules 200 of multiple activated slave devices 106 transmit the self identification sequence codes based on the unique addresses of each of the activated slave devices 106. For example, the timing at which the load module 200 of an activated slave device 106 transmits an associated self identification sequence code is based on the address of the slave device 106. The unique address of the slave device 106 may include one or more numbers, such as an eight-bit sequence of the numbers zero and one. The slave device 106 may delay transmission of the self identification sequence code for a time period following activation of the slave device 106 that is based on one or more numbers of the address of the load module 200 of the slave device 106. As the addresses for the load modules 200 of the multiple concurrently activated slave devices 106 are unique and different, the activated slave devices 106 may avoid simultaneously or concurrently transmitting the self identification sequence codes to the master control device 104. Alternatively, the delay in sending the self identification sequence codes may be based on another predetermined time delay associated with the activated slave device 106.

The self identification sequence code can be transmitted to the master control device 104 along the communications pathway 108. In the illustrated embodiment, the master control device 104 includes a receiver 222 that receives the self identification sequence code. Upon receipt of the self identification sequence code, the master control device 104 may update a table or database of the slave devices 106 that is stored on the computer readable storage medium 204. For example, the master control device 104 can maintain a list of slave devices 106 or associated load modules 200 that are coupled with the communications pathway 108 and/or the slave devices 106 that are powered on or activated. The table, database, or list of slave devices 106 or load modules 200 may periodically change. As new slave devices 106 are coupled to the communications pathway 108 and are powered by the master control device 104, the table, database, or list of slave devices 106 is updated to include the new slave devices 106.

In one embodiment, the responsive signals transmitted by the load modules 200 to the master control device 104 include health signals. For example, the load modules 200 may periodically transmit a health signal to the master control device 104 through the communications pathway 108. The receiver 222 of the master control device 104 receives the health signal. The health signal notifies the master control device 104 that the slave device 106 is still coupled with the communications pathway 108 and is able to transmit signals through the communications pathway 108. The failure of one or more of the slave devices 106 to transmit the health signal may indicate to the master control device 104 that those slave devices 106 are no longer coupled with the communications pathway 108 and/or are no longer functioning. As a result, the master control device 104 can update the table, database, or list of available slave devices 106. As described above, the load modules 200 may wait a predetermined time period after the conductive pathway 108 is available before transmitting the associated health signals to the master control device 104.

After being activated by the master control device 104, the load module 200 of the activated slave device 106 may store information related to the master control device 104. For example, the load modules 200 of the slave devices 106 may include a tangible and non-transitory computer readable storage medium 224, such as a memory, on which a unique address of the master control device 104 is stored. The slave devices 106 may receive the address of the master control device 104 in the power signal that activates the slave device 106. For example, the master control device 104 may encode the address of the master control device 104 in the power signal that is transmitted to the slave device 106. The slave device 106 stores the address of the master control device 104 in the computer readable storage medium 224. Both the master control device 104 and the slave device 106 may now be aware of each other and the ability to transmit signals between each other.

Once the master control device 104 is aware of the activated slave device 106, such as by receiving the self identification sequence code of the slave device 106, the microcontroller 202 of the master control device 104 directs the signal modulator 206 to transmit a capture signal to the slave device 106 in one embodiment. The capture signal is transmitted through the communications pathway 108 to the slave device 106 and notifies the slave device 106 that the master control device 104 is aware of and/or able to communicate with the slave device 106. The capture signal may include the address of the master control device 104. Once the capture signal is received by the slave device 106, both the master control device 104 and the slave device 106 may be aware of the ability to communicate with each other.

The microcontroller 202 directs the signal modulator 206 of the master control device 104 to create a command signal in one embodiment. The command signal is transmitted along the communications pathway 108 that is common to the slave devices 106A, 106B, 106C, 106D. The command signal is communicated to the load modules 200 of the slave devices 106 to direct one or more of the slave devices 106 to take an action. For example, the command signal may direct a contactor or a switch to open or close. In another example, the command signal may direct a sensor to obtain a reading or measurement.

In one embodiment, only the slave devices 106 having an address that matches the address encoded in the command signal act in response to the command signal. The command signal may be created in a manner similar to the power signal. For example, the signal modulator 206 may generate the command signal by pulsing the current supplied by the power source 208. The signal modulator 206 can use pulsed wave modulation, phase shift modulation, amplitude modulation, and/or frequency modulation to pulse the direct current from a battery and create the command signal. The command signal is transmitted to the slave devices 106 along the same communications pathway 108 that the power signals are communicated in one embodiment. The command signal includes one or more encoded actions that are to be performed by one or more of the slave devices 106. The action may be encoded in the command signal by changing the duration and/or frequency of one or more pulses of current from the power source 208. The address of one or more of the activated slave devices 106 may be encoded or included in the command signal.

The communications device 220 of the load module 200 in the slave device 106 receives the command signal. In one embodiment, the communications device 220 demodulates the command signal to determine if the address encoded in the command signal matches the address of the slave device 106. If the address in the command signal matches the address of the slave device 106, the communications device 220 of the slave device 106 determines that the associated command signal is directed to the slave device 106 and that the slave device 106 should act in response to receiving the command signal. Conversely, if the address encoded in the command signal does not match the address of the slave device 106, then the communications device 220 of the slave device 106 may direct the slave device 106 to ignore the command signal and/or direct the slave device 106 not to act in response to the command signal.

The command signal may be encoded with an address of the load module 200 of one or more slave devices 106 to which the command signal is directed. If the load modules 200 are not associated with addresses or if multiple load modules 200 have a common address but are coupled with a sub-master load module 200, then the command signal may be directed to the sub-master load module 200, which then conveys the command signal to the one or more load modules 200 coupled with the sub-master load module 200.

The command signal may include an address of the master control device 104. The load module 200 of the slave device 106 receives the command signal and can decode the address of the master control device 104. The communications device 220 compares the address of the master control device 104 that is encoded in the command signal (the “encoded master address”) with the address of the master control device 104 stored in the computer readable storage medium 224 (the “stored master address”). If the encoded master address matches or otherwise corresponds to the stored master address, the communications device 220 of the slave device 106 determines that the associated command signal is transmitted from the master control device 104 and that the slave device 106 should act in response to receiving the command signal. Conversely, if the encoded master address does not match the stored master address, then the communications device 220 of the slave device 106 may direct the slave device 106 to ignore the command signal and/or direct the slave device 106 not to act in response to the command signal.

The load modules 200 include load controllers 218 in the illustrated embodiment. The load controllers 218 may be microcontrollers, processors, or other logic devices. The load controller 218 of the slave device 106 to which the command signal is addressed directs the slave device 106 to take the action prescribed by the command signal. For example, the load controller 218 may cause a contactor to open, a switch to close, or a sensor to obtain a reading if the command signal is directed to the slave device 106 associated with the load module 200.

In one embodiment, the microcontroller 202 of the master control device 104 ends transmission of signals from the signal modulator 206 after the command signal is transmitted along the communications pathway 108. For example, the microcontroller 202 may direct the signal modulator 206 to stop pulsing the current supplied by the power source 208. After receiving the command signal, the load controller 218 of the slave device 106 to which the command signal is directed determines if the slave device 106 performed the requested action. For example, if the command signal directed to the slave device 106C directs the slave device 106C to obtain a sensor reading and the slave device 106C successfully obtains the sensor reading, then the load controller 218 may direct the communications device 220 to create and transmit a feedback signal as a responsive signal sent to the master control device 104.

The communications device 220 may encode the address of the master control device 104 and/or the address of the load module 200 and/or the slave device 106 in the feedback signal. The master control device 104 may decode the addresses to determine if the feedback signal is directed to the master control device 104 and/or to determine which load module 200 or slave device 106 transmitted the feedback signal. In one embodiment, one or more of the load modules 200 that is coupled with a sub-master load module 200 transmits the feedback signal to the sub-master load module 200, which encapsulates the feedback signal into a data signal transmitted from the sub-master load module 200 to the master control device 104. The sub-master load module 200 may encode the address of the sub-master load module 200 in the data signal to the master control device 104.

As described above, the load modules 200 may be identified by the master control device 104 based on transmission characteristics associated with the data signals transmitted by the load modules. For example, the load modules 200 wait for a predetermined transmission time delay after the conductive pathway 108 is available before transmitting signals to the master control device 104. In one embodiment, the load modules 200 wait the transmission time delay after the conductive pathway 108 is available before transmitting the associated feedback signals. The master control device 104 may use these time delays to differentiate which load modules 200 transmit different signals.

In one embodiment, the master control device 104 uses one or more intrinsic characteristics of the load modules 200 to identify which load module 200 transmitted a data signal to the master control device 104. An intrinsic characteristic represents an unassigned parameter associated with the load module 200 that differs from an intrinsic characteristic representative of one or more other load modules 200. The intrinsic characteristic may be related to or caused by variances in the manufacture of the load modules 200. For example, two or more similar load modules 200 manufactured at the same location or facility may be slightly different such that the load modules 200 transmit data signals, such as feedback signals, after different transmission time delays. In one embodiment, the intrinsic characteristics are unassigned parameters in that the intrinsic characteristics are not selectively applied to the load modules 200 by a human operator or automatically programmed by a device, such as the master control device 104. For example, in contrast to a unique address that is purposefully or randomly assigned to the load module 200, the intrinsic characteristics may be incapable of being selected for a load module 200, such as by a human operator or manufacturer of the load module 200.

Alternatively, one or more of transmission characteristics and/or the intrinsic characteristics of the load modules 200 may be preprogrammed into the load modules 200, such as being programmed into the hard wired logic of the load modules 200.

In another embodiment, the master control device 104 may identify which load modules 200 transmit different data signals based on different signal propagation characteristics of the conductive pathway 108 over which the load modules 200 transmit the data signals. The signal propagation characteristics can include parameters of the sections of the conductive pathway 108 that a signal transmitted by a load module 200 passes through to reach the master control device 104. For example, a signal propagation characteristic may include the distance that signals transmitted by the load module 200 must travel to reach the master control device 104. A first load module 200 may be closer to the master control device 104 than the second load module 200. As a result, the signals transmitted by the first load module 200 may arrive at the master control device 104 before signals transmitted by the second load module 200.

Another signal propagation characteristic can be differences in temperature of the conductive pathway 108 between the load module 200 and the master control device 104. The first load module 200 and/or the section of the conductive pathway 108 extending between the first load module 200 and the master control device 104 may be disposed in a location having greater temperature than the second load module 200 and/or the section of the conductive pathway 108 extending between the second load module 200 and the master control device 104. As a result, the signals transmitted by the first load module 200 take a different amount of time than the signals transmitted by the second load module 200 to arrive at the master control device 104.

The signal propagation characteristics may include electric characteristics of the section of the conductive pathway 108 that extends from the load module 200 to the master control device 104. The section of the conductive pathway 108 that extends from the first load module 200 to the master control device 104 may have one or more different electric impedance characteristics, resistance characteristics, resistivity characteristics, capacitance characteristics, and the like, than the section of the conductive pathway 108 that extends from the second load module 200 to the master control device 104. As a result, the signals transmitted by the first and second load modules 200 can arrive at the master control module 104 at different times.

The first load module 200 and/or the section of the conductive pathway 108 extending between the first load module 200 and the master control device 104 may be disposed in a location having greater temperature than the second load module 200 and/or the section of the conductive pathway 108 extending between the second load module 200 and the master control device 104. As a result, the signals transmitted by the first load module 200 take a different amount of time than the signals transmitted by the second load module 200 to arrive at the master control device 104.

The master control device 104 can learn the transmission time delays that the load modules 200 wait before transmitting signals based on previous communications with the load modules 200. For example, the master control device 104 may determine how long a load module 200 waits before transmitting signals based on a time period or delay between the master control device 104 initially transmitting a power signal to the load module 200 and the load module 200 responding with a self identification sequence code. The master control device 104 stores this time period as the transmission time delay of the load module 200. The master control device 104 may periodically update the transmission time delay to account for changes in the signal propagation characteristics and other characteristics associated with the conductive pathway 108 and/or the load module 200. By self-learning the transmission time delays of the load modules 200, additional load modules 200 may be added to the system 102 without requiring technical expertise in reprogramming or rewiring the master control device 104 and/or load modules 200.

The receiver 222 of the master control device 104 receives and decodes the feedback signal to determine if the action requested by the command signal was successfully performed by the slave device 106. The receiver 222 issues a signal to the microcontroller 202 to notify the microcontroller 202 if the slave device 106 was successful in performing the action directed by the command signal. For example, if the command signal directed the slave device 106B to close a relay or switch and the slave device 106B was unable to close the relay or switch due to a malfunction of the slave device 106B, then the feedback signal from the slave device 106B to the master control device 104 may indicate that the slave device 106B was unsuccessful in closing the relay or switch. The receiver 222 notifies the microcontroller 202 that the slave device 106B was unsuccessful. The microcontroller 202 may then issue another power, address, and/or command signal to the slave device 106B.

In one embodiment, the slave devices 106 may communicate feedback signals to configure the master control device 104. For example, the slave devices 106A, 106B, 106C, 106D may require different amounts of energy from the power signal in order to be activated by the power signal. During a time period when the slave devices 106A, 106B, 106C, 106D are activated and energized, the slave devices 106A, 106B, 106C, 106D may transmit feedback signals to the master control device 104. The feedback signals may include the unique addresses of the slave devices 106A, 106B, 106C, 106D and an amount of power or energy that the associated slave devices 106A, 106B, 106C, 106D require to be activated. The master control device 104 may receive the feedback signals and store the power or energies required by the slave devices 106A, 106B, 106C, 106D along with the respective addresses of the slave devices 106A, 106B, 106C, 106D in the computer readable storage medium 204. When the master control device 104 communicates the power signal to the slave devices 106A, 106B, 106C, 106D, the master control device 104 may refer to the amounts of power or energy required by the slave devices 106A, 106B, 106C, 106D that are stored in the medium 204 and adjust the power signal accordingly.

One or more embodiments of the communication system 102 may be used to retrofit an existing vehicle 100 (shown in FIG. 1). For example, the vehicle 100 may include several conductive wires or buses that electrically couple controller devices with controlled devices. The controller devices may be coupled with the controlled devices by at least two wires or buses, such as a data signal wire that communicates data and a power wire that transfers power. The vehicle may be retrofitted to include the communication system 102 by using the data signal wire to both power the slave device and communicate command signals to the slave device.

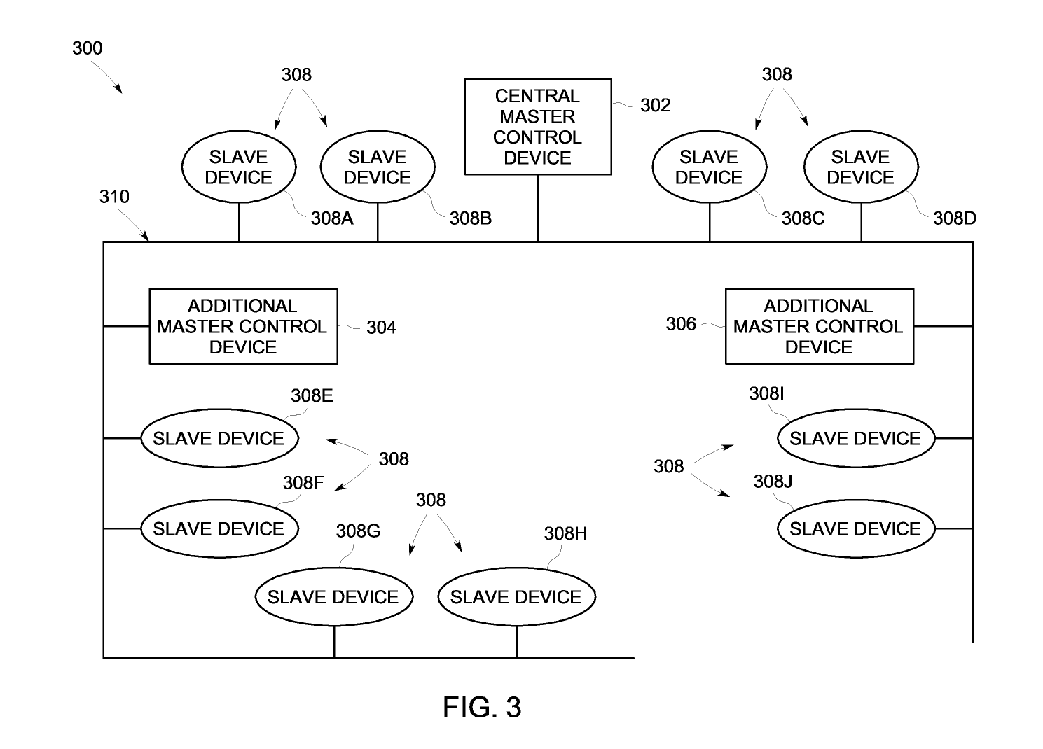

FIG. 3 is a diagram of an expandable communication system 300 in accordance with one embodiment. The communication system 300 may be similar to the communication system 102 (shown in FIG. 1). For example, the communication system 300 may include one or more master control devices 302, 304, 306 that are similar to the master control device 104 (shown in FIG. 1) and one or more slave devices 308 that are similar to the slave devices 106 (shown in FIG. 1). The master control devices 302, 304, 306 and slave devices 308 may communicate with each other through a communications pathway 310 that is similar to the communications pathway 108 (shown in FIG. 1). For example, the master control devices 302, 304, 306 and slave devices 308 may communicate through a common or single bus or wire that defines the communications pathway 310.

The communication system 300 is expandable in that many master control devices 302, 304, 306 and associated slave devices 308 may be repeatedly added to the communication system 300 at different times. For example, master control devices 302, 304, 306 and/or slave devices 308 may be periodically added or replaced with replacement devices 302, 304, 306, 308. In one embodiment, the communication system 300 includes a central master control device 302 that is coupled with additional master control devices 304, 306 by the communications pathway 310. The additional master control devices 304, 306 may be referred to as sub-master control devices in that the master control devices 304, 306 respond and may be controlled by the central master control device 302 yet also control one or more slave devices 308. The central and additional master control devices 302, 304, 306 may authenticate themselves with each other in a manner similar to the authentication of the slave devices 106 (shown in FIG. 1) described above. For example, the central and additional master control devices 302, 304, 306 may exchange addresses of each other and/or periodically transmit health signals to notify each other of the presence or availability of the other.

Each of the master control devices 302, 304, 306 can be associated with a set or group of the slave devices 308. In the illustrated embodiment, the slave devices 308 having the reference numbers 308A, 308B, 308C, and 308D are associated with the central master control device 302, the slave devices 308E, 308F, 308G, and 308H are associated with the additional master control device 304, and the slave devices 308I and 308J are associated with the additional master control device 306. Similar to as described above, the slave devices 308 may be powered by and self-authenticate themselves to the associated master control device 302, 304, 306. The master control devices 302, 304, 306 transmit command signals to the associated slave devices 308. In one embodiment, the central master control device 302 may power and/or transmit command signals to a slave device 308 associated with another master control device 304, 406. For example, the central master control device 302 may direct the additional master control device 304 to power and/or transmit a command signal to the slave device 308G.

The additional master control devices 304, 306 may be associated with the central master control device 302 in a manner that is similar to the association between the slave devices 106 (shown in FIG. 1) and the master control device 104 (shown in FIG. 1). For example, when an additional master control device 304, 306 is initially joined with the communications pathway 310, the additional master control device 304, 306 may being a self-authentication process that is similar to the self-authentication process described above in connection with the slave devices 106. Once the central and additional master control devices 302, 304, 306 are aware of each other, such as by exchanging and storing the respective addresses of each other, the additional master control devices 304, 306 may communicate with the central master control device 302.

Feedback signals are transmitted by the slave devices 308 to the associated master control device 302, 304, 306. The master control device 302, 304, 306 may then encode the feedback signal into another signal that is re-transmit the feedback signal through the conductive pathway 310 to another master control device 302, 304, 306. The master control device 302, 304, 306 that re-transmits the feedback signal (the “re-transmitting master control device 302, 304, 306”) may encode the address of the re-transmitting master control device 302, 304, 306 into the feedback signal. The master control device 302, 304, 306 that receives the re-transmitted signal may then determine, based on the addresses encoded in the feedback signal, which slave devices 308 and/or master control devices 302, 304, 306 transmitted and re-transmitted the feedback signal.

In one embodiment, the number of slave devices 308 that can be associated with a master control device 302, 304, 306 may be predetermined and/or fixed. In order to extend the communication system 300, one or more of the slave devices 308 may become a sub-master device with one or more additional slave devices 308 being associated with the sub-master slave device 308. For example, the slave device 308H may be associated with the slave device 308G, with the slave device 308G being the sub-master slave device 308G. The sub-master slave device 308G may activate and/or transmit command signals to the slave device 308H. The power and/or command signals may originate at one or more of the master control devices 302, 304, 306 and/or at the sub-master slave device 308G. The sub-master slave device 308G and the slave device 308H may authenticate themselves with each other similar to the master control device 104 (shown in FIG. 1) and the slave device 106 (shown in FIG. 1), as described above. The sub-master slave device 308G may receive feedback signals from the slave device 308H and encode the address of the sub-master slave device 308G in the feedback signal before conveying the feedback signal to another sub-master slave device 308 or master control device 302, 304, 306.

The ability to add additional master control devices 304, 306 and/or slave devices 308 to the communications system 300 may enable the system 300 to be more easily expanded without significant changes to the system 300. For example, additional master control devices 304, 306 and/or slave devices 308 may be added to the communications pathway 310 after the communications system 300 is put into use or is being used, such as when the wiring of a vehicle is retrofitted with the communication system 300. As the master control devices 302, 304, 306 and slave devices 308 may authenticate with each other and/or track which ones of the master control devices 302, 304, 306 and slave devices 308 remain active and coupled with the communications pathway 310, additional master control devices 302, 304, 306 and slave devices 308 may be added without significant changes to the system 300. For example, a relatively untrained person may add or switch out a slave device 308 and/or master control device 302, 304, 306 without altering the memory, software, hard-wired instructions, and the like, of the master control devices 302, 304, 306 and/or slave devices 308.

In one embodiment, command signals transmitted by master control devices 302, 304, 306 may be ignored by one or more of the slave devices 108. For example, the master control device 304 may transmit a command signal to the slave device 308G while the slave devices 308E, 308F ignore the command signal. The slave devices 308E, 308F can be configured to ignore the command signal. For example, the slave devices 308E, 308F may have a predetermined response time between the load modules 200 (shown in FIG. 2) receiving a command signal and the communications device 220 (shown in FIG. 2) of the load modules 200 demodulating the command signal and/or directing the load controllers 218 (shown in FIG. 2) to take an action requested by the command signal. If this response time is slower than a frequency of the modulated command signal, then the slave devices 308E, 308F may ignore the command signal. For example, if the command signal is transmitted at a frequency of 10 kHz and the load modules 200 of the slave devices 308E, 308F require 100 milliseconds or more to demodulate the command signal and direct the load controllers 218 to take the action requested by the command signal, then the command signal is ignored by the slave devices 308E, 308F.

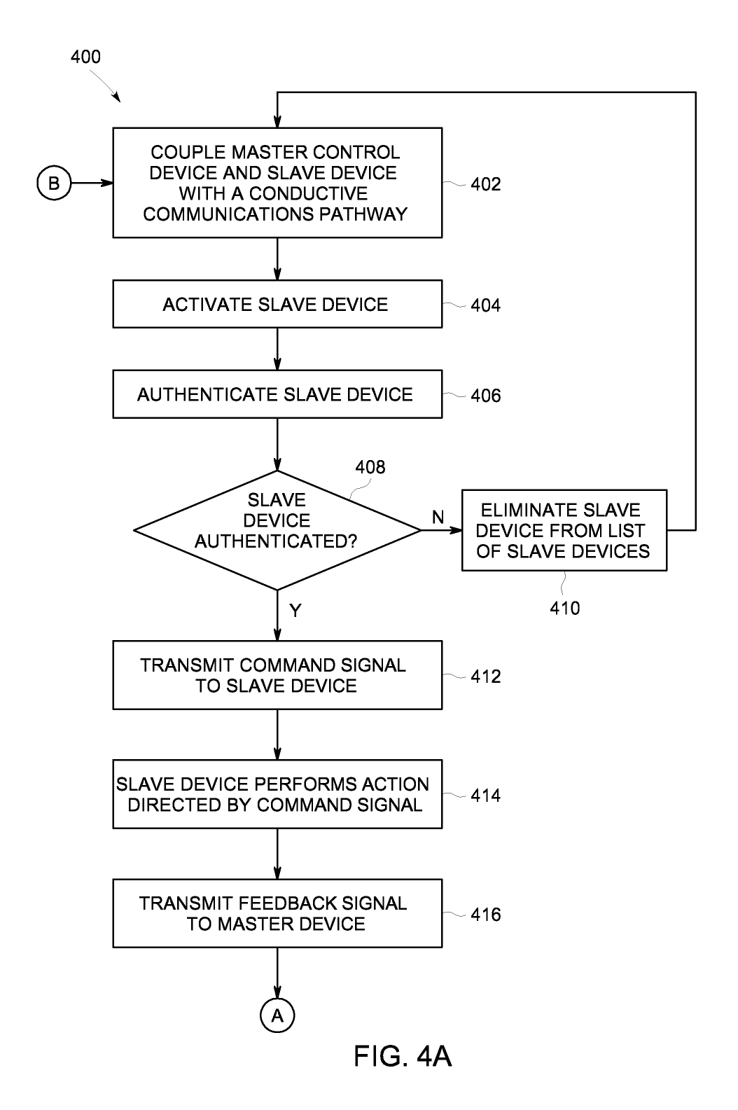

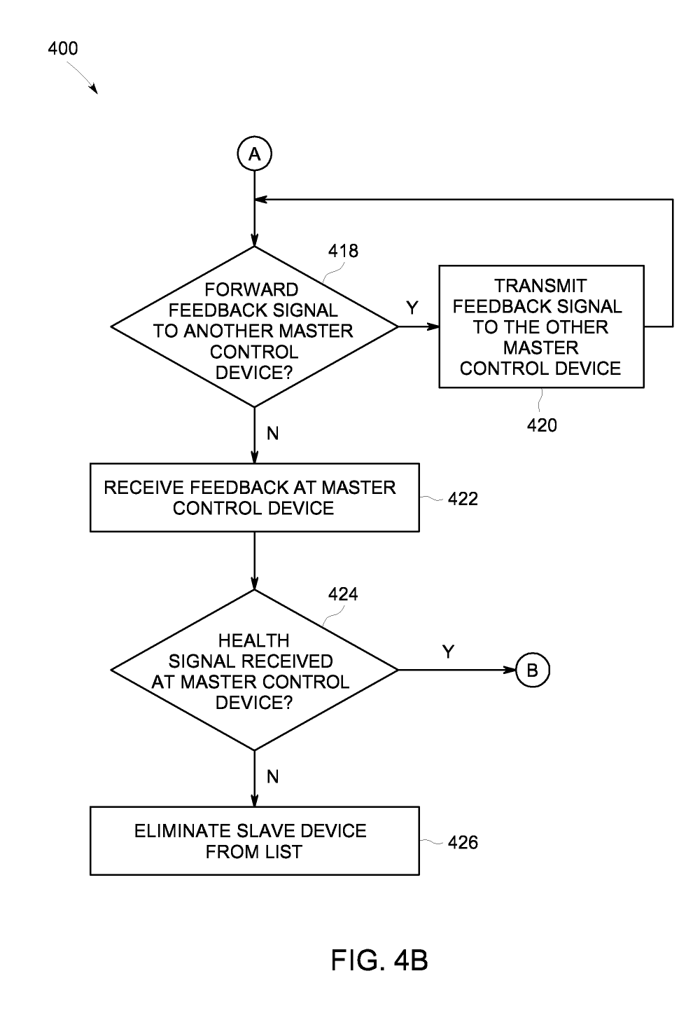

FIGS. 4A and 4B illustrate a flowchart of a method 400 for communicating through a common or single communications pathway within a communications system in accordance with one embodiment. The method 400 may be used in conjunction with the communication systems 102, 300 (shown in FIGS. 1 and 3).

At 402, a master control device and a slave device are electrically coupled with a common or single conductive pathway. For example, the master control device 104 (shown in FIG. 1) may be electrically coupled with the slave device 106 (shown in FIG. 1) by the communications pathway 108 (shown in FIG. 1). The communications pathway 108 may be a single conductive wire or bus. Alternatively, the communications pathway 108 may be several conductive wires and/or buses that are serially joined with each other. In one embodiment, the communications pathway 108 does not include two or more conductive wires or buses disposed in parallel with each other. The master control device 104 and slave device 106 may be coupled with a preexisting communications pathway 108, such as a bus or wire of a vehicle. For example, the method 400 may be used to retrofit a communication system of a vehicle by coupling the master control device 104 and slave device 106 to a common or single bus or wire in a vehicle that previously was used in another circuit, communications system, or for another purpose.

At 404, the slave device is activated. For example, the master control device 104 (shown in FIG. 1) may transmit a power signal to the slave device 106 (shown in FIG. 1) by pulsing the direct current supplied by the power source 208 (shown in FIG. 2). The power signal is transmitted to the slave device 106 (shown in FIG. 1) along the communications pathway 108 (shown in FIG. 1). The power signal is received at the slave device 106 and is used to energize and/or activate the slave device 106.

At 406, the slave device is authenticated. For example, the slave device 106 (shown in FIG. 1) may self-authenticate by transmitting a self identification sequence code to the master control device 104 (shown in FIG. 1). The self identification sequence code is transmitted through the communications pathway 108 (shown in FIG. 1).

At 408, a determination is made as to whether the slave device is authenticated. For example, the master control device 104 (shown in FIG. 1) may determine if the slave device 106 (shown in FIG. 1) transmitted an associated self identification sequence code to the master control device 104 at 406. If the slave device 106 did not transfer the self identification sequence code or the self identification sequence code received by the master control device 104 does not correspond with the slave device 106 that was activated at 404, then the master control device 104 may determine that the slave device 106 that was selected to be activated (the “selected slave device 106”) was not activated. As a result, flow of the method 400 proceeds to 410. Conversely, if the slave device 106 did transmit the self identification sequence code to the master control device 104 and the master control device 106 determined that the self identification sequence code corresponds with the selected slave device 106, then the master control device 104 determines that the selected slave device 106 was activated. As a result, flow of the method 400 proceeds to 412.

At 410, the selected slave device is removed from a list, table, or database of available slave devices. For example, if the selected slave device 106 (shown in FIG. 1) does not authenticate itself to the master control device 104 (shown in FIG. 1), then the master control device 104 may remove the selected slave device 106 from a roster of potentially available slave devices 106 that are coupled with the communications pathway 108 (shown in FIG. 1). Flow of the method 400 may return to 402, where an additional slave device may be coupled with the master control device via the communications pathway.

At 412, a command signal is transmitted to the selected slave device. For example, the master control device 104 (shown in FIG. 1) may transmit a command signal on the same communications pathway 108 (shown in FIG. 1) that the power signal is transmitted along. The command signal directs the selected slave device 106 to perform an action, such as open or close a relay, switch, or contactor, or obtain a sensor reading.

At 414, the selected slave device performs the action directed by the command signal. For example, the slave device 106 (shown in FIG. 1) may open or close a relay, switch, or contactor, or obtain a sensor reading in response to receiving the command signal.

At 416, the slave device transmits a feedback signal to the master control device. For example, the selected slave device 106 (shown in FIG. 1) may transmit a signal to the master control device 104 (shown in FIG. 1) that informs the master control device 104 of the success or failure of performing the action requested by the command signal. If the command signal directed the slave device 106 to close a contactor and the slave device 106 was unable to close the contactor, then the slave device 106 may transmit a feedback signal to the master control device 104 that informs the master control device 104 that the contactor is still open. Conversely, if the slave device 106 was able to close the contactor, then the slave device 106 may transmit a feedback signal to the master control device 104 that informs the master control device 104 that the contactor is closed. The master control device 104 may then re-transmit another power, address, and/or command signal to the slave device 106 in order to request that the slave device 106 attempt to perform the requested action again.

At 418, a determination is made as to whether the feedback signal is to be forwarded on to another master control device. For example, the selected slave device 106 (shown in FIG. 1) may be associated with a sub-master control device 104 (shown in FIG. 1), an additional master control device 304, 306 (shown in FIG. 3), and/or another slave device 106 acting as a sub-master control device. The sub-master control device 104, 304, 306 or other slave device 106 may, in turn, be associated with another master or sub-master control device 104, 302, 304, 306 (shown in FIGS. 1 and 3). If the feedback signal is received by a master or sub-master control device (the “receiving device”) and the feedback signal is addressed to another master or sub-master control device (the “addressed device”), then the receiving device determines that the feedback signal is to be re-transmitted along the communications pathway to the addressed device. As a result, flow of the method 400 flows to 420. Conversely, if the feedback signal is received by the addressed device, then flow of the method 400 flows to 422.

At 420, the feedback signal is re-transmitted along the communications pathway to one or more master or sub-master control devices. The method 400 may continue in a loop between 418 and 420 until the feedback signal is transmitted to the addressed device.

At 422, the addressed master control device receives the feedback signal. If the feedback signal indicates that the selected slave device was unsuccessful in performing the requested action, then the master control device may re-transmit another power and/or command signal. Alternatively, the master control device may store the feedback signal and/or data included in the feedback signal in a computer readable storage medium, such as a memory.

At 424, a determination is made as to whether the master control device has received a health signal from the selected slave device within a predetermined time period or window. For example, the master control device 104 (shown in FIG. 1) may determine if the selected slave device 106 (shown in FIG. 1) has transmitted a health signal before expiration of a countdown timer. If the master control device has not received the health signal within the time period, then the lack of a health signal from the selected slave device may indicate that the selected slave device is malfunctioning or is disconnected from the communications pathway. As a result, flow of the method 400 flows to 426. Conversely, if the master control device does receive the health signal, then the health signal may indicate that the slave device is functioning properly and/or is coupled with the communications pathway. As a result, flow of the method 400 may return to 404 so that the master control device may power and control another slave device or the selected slave device again.

At 426, the selected slave device is removed from a list, table, or database of slave devices that are available to the master control device. For example, the master control device 104 (shown in FIG. 1) may maintain a list of slave devices 106 (shown in FIG. 1) that are available to perform one or more actions. If no health signal is received from the selected slave device 106, then the master control device 104 determines that the selected slave device 106 is no longer available and may remove the selected slave device 106 from the list.

In one embodiment, a communication system includes: a master control device capable of being coupled with a conductive communications pathway of a group of conductive pathways, the master control device including a signal modulator configured to transmit a power signal and a command signal along the communications pathway by modulating an electric current supplied by a power source joined with the preexisting group of conductive pathways; and a load module capable of being coupled with the communications pathway in series with the master control device and of being coupled with a slave device, the load module configured to receive the power signal and the command signal from the master control device along the communications pathway, wherein the power signal activates the load module and the command signal directs the load module to control the slave device and to cause the slave device to take an action.

In another aspect, the communications pathway over which the power signal and command signal are transmitted comprises a single serial pathway with a return to ground.

In another aspect, the group of conductive pathways comprises one or more conductive wires or busses that are electrically coupled with each other in series, and wherein the master control device and the load module are configured to communicate through said one or more conductive wires or busses that are electrically coupled with each other in series.

In another aspect, the load module is remotely located from the master control device.

In another aspect, the master control device and the load module are configured to communicate through the communications pathway formed from one or more conductive wires or busses that are electrically coupled with each other in series.

In another aspect, the load module is configured to transmit a self identification sequence code to the master control device when the load module is activated by the master control device to authenticate the load module to the master control device.

In another aspect, the load module includes a current conversion device that receives the power signal and converts the power signal into an electric current that powers the load module.

In another aspect, the load module has a uniquely defined address and the signal modulator includes the address of the load module in the command signal.

In another aspect, the load module communicates a feedback signal to the master control device through the conductive communications pathway, the master control device identifying the load module as transmitting the feedback signal based on a transmission time delay that the load module waited before transmitting the feedback device.

In another aspect, the load module communicates a feedback signal to the master control device through the conductive pathway, the master control device identifying the load module as transmitting the feedback signal based on at least one of a transmission characteristic of the load module, an unassigned intrinsic characteristic of the load module, or a signal propagation characteristic of the conductive pathway over which the feedback signal is transmitted by the load module.

In another aspect, a plurality of the load modules are capable of being coupled with the master control device by the communications pathway and with a plurality of the slave devices, and the master control device is configured to transmit the command signal such that the command signal is received by a first load module of the plurality of load modules and ignored by a second load module of the plurality of load modules.

In another aspect, the load module communicates a feedback signal to the master control device, the feedback signal indicating whether the slave device performed the action directed by the command signal.

In another aspect, the slave device that is controlled by the load module includes one or more of a switch, a relay, or a sensor.

In another aspect, the master control device is configured to maintain a list of available slave devices, the load module configured to transmit a health signal to the master control device with the master control device altering the list based on the health signal.

In another aspect, the power source to which the signal modulator is coupled includes an energy storage device.

In another aspect, the group of conductive pathways is a preexisting group of conductive pathways.

In another embodiment, a method for communicating in a communication system includes: transmitting a power signal and a command signal from a master control device to a load module coupled with a slave device along a conductive communications pathway of a group of conductive pathways, the power signal and the command signal transmitted by modulating an electric current supplied by a power source; receiving the power signal at the load module and activating the load module based on energy of the power signal; and receiving the command signal at the load module, the load module directing the slave device to take an action based on the command signal.

In another aspect, the conductive communications pathway comprises one or more conductive wires or busses that are electrically coupled with each other in series, the power signal and the command signal being communicated over said one or more conductive wires or busses.

In another aspect, the method also includes communicating a feedback signal from the load module to the master control device, the feedback signal indicating whether the slave device performed the action based on by the command signal.

In another aspect, the method also includes transmitting a responsive signal from the load module to the master control device after a transmission time delay from the load module receiving the command signal; and identifying the load module based on the transmission time delay.

In another aspect, the command signal directs the load module to cause one or more of a switch, a relay, or a sensor to take the action.

In another aspect, the step of receiving the power signal includes converting the power signal into an electric current that powers the load module.

In another aspect, the method further includes transmitting a self authenticating code to the master control device when the load module is activated by the power signal.

In another aspect, the transmitting step includes transmitting the power signal and the command signal along a preexisting group of conductive pathways.

In another embodiment, a communication system includes: a master control device capable of being coupled with a conductive communications pathway formed from one or more conductive bodies joined in series with each other and formerly used to communicate data signals in a vehicle, the master control device including a signal modulator configured to transmit a power signal and a command signal along the communications pathway by modulating an electric current supplied by a power source; and a load module capable of being coupled with the communications pathway and with a slave device, the load module configured to receive the power signal and the command signal from the master control device along the communications pathway, wherein the power signal activates the load module and the command signal directs the load module to control the slave device and to cause the slave device to take an action.

In another aspect, the load module transmits a self identification sequence code to the master control device when the load module is activated by the master control device to authenticate the load module to the master control device.

In another aspect, the load module communicates a feedback signal to the master control device, the feedback signal indicating whether the slave device performed the action directed by the command signal.

In another aspect, the master control device is configured to maintain a list of available slave devices, the load module configured to transmit a health signal to the master control device with the master control device altering the list based on the health signal.

Another embodiment relates to a method for communicating in a communication system (e.g., in a vehicle). The method comprises transmitting a power signal and a command signal from a master control device to a load module (the load module is coupled with a slave device) along a single serial pathway with a return to ground. (Single serial pathway refers to one electrical communications path, as opposed to more than one in parallel, which may comprise a cable, other electrical conductor, or plural electrical conductors connected in series; return to ground includes a ground line or a chassis or other ground.) The method further comprises receiving the power signal at the load module and activating the load module based on energy of the power signal. The method further comprises receiving the command signal at the load module, and the load module directing the slave device to take an action based on the command signal. In another embodiment, the power signal and the command signal are transmitted by modulating an electric current supplied by a power source.

As used herein, an element or step recited in the singular and proceeded with the word “a” or “an” should be understood as not excluding plural of said elements or steps, unless such exclusion is explicitly stated. Furthermore, references to “one embodiment” or “an embodiment” of the presently described subject matter are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the disclosed subject matter without departing from its scope. While the dimensions and types of materials described herein are intended to define the parameters of the disclosed subject matter, they are by no means limiting and are exemplary embodiments. Many other embodiments will be apparent to those of skill in the art upon reviewing the above description. The scope of the described subject matter should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose several embodiments of the described subject matter, including the best mode, and also to enable any person of ordinary skill in the art to practice the embodiments of subject matter, including making and using any devices or systems and performing any incorporated methods. The patentable scope of the subject matter is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

What is claimed is:

1. A communication system comprising:
a master control device capable of being coupled with a conductive communications pathway of a group of conductive pathways, the master control device including a signal modulator configured to transmit a power signal and a command signal along the communications pathway by modulating an electric current supplied by a power source joined with the group of conductive pathways; and
a load module capable of being coupled with the communications pathway in series with the master control device and of being coupled with a slave device, the load module configured to receive the power signal and the command signal from the master control device along the communications pathway, wherein the power signal activates the load module and the command signal directs the load module to control the slave device and to cause the slave device to take an action.

2. The communication system of claim 1, wherein the communications pathway over which the power signal and command signal are transmitted comprises a single serial pathway with a return to ground.

3. The communication system of claim 1, wherein the group of conductive pathways comprises one or more conductive wires or busses that are electrically coupled with each other in series, and wherein the master control device and the load module are configured to communicate through said one or more conductive wires or busses that are electrically coupled with each other in series.

4. The communication system of claim 1, wherein the load module is configured to transmit a self identification sequence code to the master control device when the load module is activated by the master control device to authenticate the load module to the master control device.

5. The communication system of claim 1, wherein the load module includes a current conversion device that receives the power signal and converts the power signal into an electric current that powers the load module.

6. The communication system of claim 1, wherein the load module has a uniquely defined address and the signal modulator includes the address of the load module in the command signal.

7. The communication system of claim 1, wherein the load module communicates a feedback signal to the master control device through the conductive communications pathway, the master control device identifying the load module as transmitting the feedback signal based on at least one of a transmission characteristic of the load module, an unassigned intrinsic characteristic of the load module, or a signal propagation characteristic of the conductive pathway over which the feedback signal is transmitted by the load module.

8. The communication system of claim 1, wherein a plurality of the load modules are capable of being coupled with the master control device by the communications pathway and with a plurality of the slave devices, the master control device configured to transmit the command signal such that the command signal is received by a first load module of the plurality of load modules and ignored by a second load module of the plurality of load modules.

9. The communication system of claim 1, wherein the slave device that is controlled by the load module includes one or more of a switch, a relay, or a sensor.

10. The communication system of claim 1, wherein the master control device is configured to maintain a list of available slave devices, the load module configured to transmit a health signal to the master control device with the master control device altering the list based on the health signal.

11. The communication system of claim 1, wherein the power source to which the signal modulator is coupled includes an energy storage device.

12. The communication system of claim 1, wherein the group of conductive pathways is a preexisting group of conductive pathways.

13. A method for communicating in a communication system, the method comprising:
transmitting a power signal and a command signal from a master control device to a load module coupled with a slave device along a conductive communications pathway of a group of conductive pathways, the power signal and the command signal transmitted by modulating an electric current supplied by a power source;
receiving the power signal at the load module and activating the load module based on energy of the power signal; and
receiving the command signal at the load module, the load module directing the slave device to take an action based on the command signal.

14. The method of claim 13, wherein the conductive communications pathway comprises one or more conductive wires or busses that are electrically coupled with each other in series, the power signal and the command signal being communicated over said one or more conductive wires or busses.

15. The method of claim 13, further comprising communicating a feedback signal from the load module to the master control device, the feedback signal indicating whether the slave device performed the action based on the command signal.

16. The method of claim 13, further comprising:
transmitting a responsive signal from the load module to the master control device after a transmission time delay from the load module receiving the command signal; and
identifying the load module based on the transmission time delay.

17. The method of claim 13, wherein the command signal directs the load module to cause one or more of a switch, a relay, or a sensor to take the action.

18. The method of claim 13, wherein the step of receiving the power signal includes converting the power signal into an electric current that powers the load module.

19. The method of claim 13, further comprising transmitting a self authenticating code to the master control device when the load module is activated by the power signal.

20. The method of claim 13, wherein the transmitting step includes transmitting the power signal and the command signal along a preexisting group of conductive pathways.

21. A communication system comprising:
a master control device capable of being coupled with a conductive communications pathway formed from one or more conductive bodies joined in series with each other and formerly used to communicate data signals in a vehicle, the master control device including a signal modulator configured to transmit a power signal and a command signal along the communications pathway by modulating an electric current supplied by a power source; and
a load module capable of being coupled with the communications pathway and with a slave device, the load module configured to receive the power signal and the command signal from the master control device along the communications pathway, wherein the power signal activates the load module and the command signal directs the load module to control the slave device and to cause the slave device to take an action.

22. The communication system of claim 21, wherein the load module transmits a self identification sequence code to the master control device when the load module is activated by the master control device to authenticate the load module to the master control device.

23. The communication system of claim 21, wherein the master control device is configured to maintain a list of available slave devices, the load module configured to transmit a health signal to the master control device with the master control device altering the list based on the health signal.
